(19) United States
(12) Patent Application Publication
(10) Pub. No.: US 2026/0193462 A1
(43) Pub. Date: Jul. 9, 2026

(54) SURFACTANT COMPRISING POLYOL/ MONOOL - EPOXY PRODUCTS AND ITS PROCESS FOR PREPARATION, COMPOSITION AND METHOD OF USE THEREOF

(71) Applicant: HERCULES LLC, Wilmington (DE)

(72) Inventors: Osama M. MUSA, Bedminster, NJ (US); Venkataram KRISHNAN, Avondale, PA (US); Brian James LARSEN, East Brunswick, NJ (US); Seher OZKAN, Clifton, NJ (US); Zeena Kottukapally CHERIAN, Exton, PA (US); Henry Keith CHENAULT, North Plainfield, NJ (US)

(21) Appl. No.: 18/868,555

(22) PCT Filed: May 23, 2023
(86) PCT No.: PCT/US2023/067349

§ 371 Date: Nov. 22, 2024

Related U.S. Application Data
(60) Provisional application No. 63/345,332, filed on May 24, 2022.
(60) Provisional application No. 63/398,463, filed on Aug. 16, 2022.

(51) Int. Cl. C08L 71/02; C09D 7/65; C09D 171/02; C09D 201/00

(52) U.S. Cl. CPC C08L 71/02; C09D 7/65; C09D 171/02; C09D 201/00

(57) ABSTRACT

Disclosed herein is a surfactant comprising a reaction product of (i) reactant A: an aliphatic polyether polyol having a weight average molecular weight of about 100 to about 4000; and (ii) reactant B: an epoxy compound having at least one epoxy group per molecule, wherein the ratio of molar equivalents of “reactant A” to molar equivalents of “reactant B” is from about 1:0.5 to about 1:4. Also disclosed are a process for preparing the surfactant and compositions comprising the surfactant, particularly, coating compositions.

### FIELD OF THE INVENTION

The present application relates to a surfactant comprising a reaction product of (i) reactant A: an aliphatic polyether polyol that has a weight average molecular weight of about 100 to about 4000; and (ii) reactant B: an epoxy compound having at least one epoxy group per molecule, wherein the ratio of molar equivalents of “reactant A” to molar equivalents of “reactant B” is from about 1:0.5 to about 1:4.

### BACKGROUND OF THE INVENTION

Surfactants are commonly employed in coating formulations to promote wetting of the substrate by the coating and wetting of the pigment by the resin. They can also boost the life of the coatings by increasing shelf stability and improving formulation latitude by preventing instability of the coating composition as different components are added. Low levels of surfactants are often utilized to achieve these goals, and surfactant combinations can be used to impart one or more of the above attributes. Surfactants are generally non-volatile compounds in ambient settings; thus, they stay in the coating after drying. At the low quantities commonly utilized, there is little effect on polymer hardness or coating performance. If there is excess of surfactant in the aqueous coating composition, the wet coating may have excessive foaming and poor thickening effectiveness with thickeners, and the cured coating could have water sensitivity, poor external durability, and poor block, stain, and print resistance. As a result, surfactants are usually utilized in the smallest doses possible to achieve their helpful characteristics while avoiding any negative consequences.

In the application of coating formulations, the ability to reduce water surface tension is critical since reduced surface tension generally corresponds to improved substrate wetting. Coatings, inks, adhesives, fountain solutions, cleaning compositions, and agricultural formulations are all examples of waterborne compositions. Surfactants are commonly used to reduce surface tension in water-based systems, resulting in improved surface coverage, fewer flaws, and more uniform dispersion. When the system is at rest, equilibrium surface tension performance is critical. The ability of a surfactant to reduce surface tension and provide wetting during high-speed application conditions, i.e., high surface formation rates, is measured by dynamic surface tension.

U.S. Pat. No. 7,550,542B2 discloses a synthetic polymer that has a water-soluble or water-swellable polymer backbone and terminal groups and/or intermediate groups of blocks of hydrophobes of alkyl- or aryl compounds containing a polymerizable cyclic monomer or a polymerizable double bond (or alkene) group or derivatives thereof. The blocks of hydrophobes are composed of two or more units of the same or different hydrophobes. These synthetic polymers are used as rheology modifiers, especially in latex paints.

U.S. Pat. No. 8,388,806B2 describes a hydrophobically modified poly [ethylene glycol] for use in pitch and stickies control in pulp and papermaking processes.

PCT application No. 202006554A1 provides a composition that include an oil, a surfactant, and optionally a charged polymer complex and methods of manufacturing the compositions. The composition may also include an aqueous phase to provide a microemulsion. The technology further provides methods of use of such compositions in home care and personal care.

JP Patent 05659340B2 describes a surfactant obtained by reacting 1 mole of a polyoxyalkylene compound containing polyoxyalkylene compound with 1-8 moles 6-21C alkyl glycidyl ether.

JP Publication 2003253197A describes an antifouling agent that contains a cross-linked polymer formed by the ring-opening addition polymerization of an epoxy compound selected from the group consisting of monool glycidyl ethers and polyol glycidyl ethers with a hydroxylated compound selected from the group consisting of monools, polyols, and polyoxyalkylene compound formed by substituting a monool or a polyol with a polyoxyalkylene group.

JP Publication 2011088113A describes an emulsifier that contains a compound which is obtained by reaction of (a) glycidyl ethers with (b) water-soluble polyalkylene glycol having hydroxyl groups at both terminals of a molecular chain to form an adduct and then by reaction of the adduct with (c) organic diisocyanate.

US Publication 20080188673A1 describes low surface tension surfactants based on ether alcohol and provides for their use as surfactants in aqueous coating formulations, said surfactants being preparable by reacting at least one hydroxy compound.

CN Publication 112939898A describes a series of epoxy compounds wherein one end is an epoxy group reacted with polyester, alkyd resin, or acrylic resin; the other end is ether chain section, suitable for casting material, glass steel winding, mould manufacturing, coating, medical applications.

There is a need for a surfactant with high surface activity in terms of pigment dispersibility, wetting and a surfactant composition that is effective in lacquer coatings, primer coatings, ink jet printings, top coatings, varnish coatings, and metallic or non-metallic coatings.

The invention relates to an improved surfactant comprising a reaction product of (i) reactant A: an aliphatic polyether polyol having a weight average molecular weight of about 100 to about 4000; and (ii) reactant B: an epoxy compound having at least one epoxy group per molecule; wherein the ratio of molar equivalents of “reactant A” to molar equivalents of “reactant B” is from about 1:0.5 to about 1:4. The invention also relates to a method of coating a substrate and to a substrate which has been coated with a coating formulation of the invention.

Therefore, the objective of this invention is to provide a surfactant that affords good equilibrium and dynamic surface tension and low foaming properties which would be widely accepted in the coating, ink, adhesive, and agricultural formulation industries.

The surfactant incorporated in the composition of this invention serves as a wetting and dispersing agent to improve coating performance with reduced film defects such as fisheyes and cratering.

The present invention comprising a surfactant and its composition is used in coating compositions that contain a reaction product of (i) reactant A: an aliphatic polyether polyol having a weight average molecular weight of about 100 to about 4000; and (ii) reactant B: an epoxy compound having at least one epoxy group per molecule; wherein the ratio of molar equivalents of “reactant A” to molar equivalents of “reactant B” is from about 1:0.5 to about 1:4.

### SUMMARY OF THE INVENTION

The primary aspect of the present application is to provide a surfactant and its composition comprising a reaction product of (i) reactant A: an aliphatic polyether polyol having a weight average molecular weight of about 100 to about 4000; and (ii) reactant B: an epoxy compound having at least one epoxy group per molecule, wherein molar equivalents of “reactant A” to number of epoxy groups in “reactant B” is from about 1:0.5 to about 1:4.

In another aspect, the present application provides a surfactant further comprising a reaction product of (i) reactant B: an epoxy compound having at least one epoxy group per molecule; and (ii) reactant C: an aliphatic alkoxylated alcohol having a weight average molecular weight of about 100 to about 4000.

In another aspect, the present application provides a reaction product of “reactant A” and “reactant B” comprising (i) from about 0.05% to about 40.0% of polyol mono-functionalized by glycidyl ether; and (ii) from about 60.0% to about 99.95% of polyol multi-functionalized by glycidyl ether.

In another aspect, the present application provides a process for preparing a surfactant comprising the process of reacting (i) about 1 molar equivalent of an aliphatic polyether polyol and (ii) about 2 molar equivalents of an epoxy compound in the presence of about 0.05 molar equivalent of a base to form a mixture of polyol mono-functionalized by the epoxy compound and at least one polyol multi-functionalized by the epoxy compound. In another aspect, the present application provides a surfactant that comprises a reaction product of: (i) polyethylene glycol (PEG) having a weight average molecular weight of about 100 to about 4000; and (ii) 2-ethylhexyl glycidyl ether (EHGE); wherein 1 molar equivalent of PEG reacts with 2 molar equivalents of EHGE to form a mixture of PEG mono-functionalized by EHGE, PEG di-functionalized by EHGE, PEG tri-functionalized by EHGE, PEG tetra-functionalized by EHGE, and PEG penta-functionalized by EHGE and having a generic structure of:

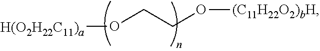

wherein each C₁₁H₂₂O₂ unit is independently

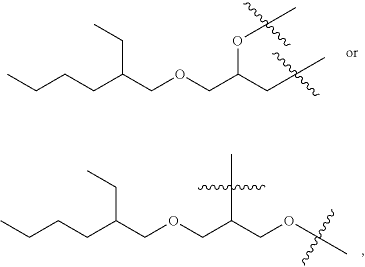 [SMILES: *CC(COCC(CC)CCCC)O* ; *OCC(*)COCC(CC)CCCC]

wherein each C₁₁H₂₂O₂ unit is attached to the polyethylene glycol core or another C₁₁H₂₂O₂ unit by a carbon-oxygen single bond; and
wherein n=2 to 90 and a+b=1 to 5, comprising
PEG mono-functionalized by EHGE, having a+b=1;
PEG di-functionalized by EHGE, having a+b=2;
PEG tri-functionalized by EHGE, having a+b=3;
PEG tetra-functionalized by EHGE, having a+b=4; and
PEG penta-functionalized by EHGE, having a+b=5.

In another aspect, the present application provides a surfactant that comprises a reaction product of: (i) aliphatic alkoxylated alcohol R—(OCH₂CHR₁)ₙ—OH; and (ii) 2-ethylhexyl glycidyl ether (EHGE); wherein 1 molar equivalent of aliphatic alkoxylated alcohol reacts with 1 molar equivalents of EHGE to form a mixture of aliphatic alkoxylated alcohol mono-functionalized by EHGE, aliphatic alkoxylated alcohol di-functionalized by EHGE, aliphatic alkoxylated alcohol tri-functionalized by EHGE, aliphatic alkoxylated alcohol tetra-functionalized by EHGE, and aliphatic alkoxylated alcohol penta-functionalized by EHGE and having a generic structure of:

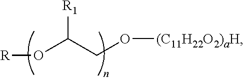

wherein each C₁₁H₂₂O₂ unit is independently

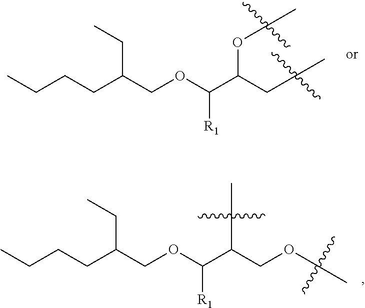

wherein each C₁₁H₂₂O₂ unit is attached to the polyethylene glycol core or another C₁₁H₂₂O₂ unit by a carbon-oxygen single bond; and
wherein R=a linear or branched alkyl group having 1 to 20 carbons, R₁=H and/or CH₃, and n=1 to 25;
wherein a=1 to 5, comprising
aliphatic alkoxylated alcohol mono-functionalized by EHGE, having a=1;
aliphatic alkoxylated alcohol di-functionalized by EHGE, having a=2;
aliphatic alkoxylated alcohol tri-functionalized by EHGE, having a=3;
aliphatic alkoxylated alcohol tetra-functionalized by EHGE, having a=4; and
aliphatic alkoxylated alcohol penta-functionalized by EHGE, having a=5.

In another aspect, the present application provides a composition comprising (i) about 5.0 wt. % to about 99.5 wt. % of surfactant comprising a reaction product of (i) reactant A: an aliphatic polyether polyol having a weight average molecular weight of about 100 to about 4000; and (ii) reactant B: an epoxy compound having at least one epoxy group per molecule; wherein the ratio of molar equivalents of “reactant A” to molar equivalents of “reactant B” is from about 1:0.5 to about 1:4 and (iii) about 0.5 wt. % to about 95.0 wt. % of at least one additive.

In another aspect, the present application provides a composition comprising (i) about 5.0 wt. % to about 99.5 wt. % of a surfactant comprising:
(a) a reaction product of (i) reactant A: an aliphatic polyether polyol having a weight average molecular weight of about 100 to about 4000; and (ii) reactant B: an epoxy compound having at least one epoxy group per molecule, wherein the ratio of molar equivalents of “reactant A” to molar equivalents of “reactant B” is from about 1:0.5 to about 1:4, and wherein the surfactant further comprises a reaction product of (i) reactant B: an epoxy compound having at least one epoxy group per molecule; and (ii) reactant C: an aliphatic alkoxylated alcohol having a weight average molecular weight of about 100 to about 4000; and
(b) about 0.5 wt. % to about 95.0 wt. % of at least one additive.

In another aspect, the present application provides a coating composition comprising (i) about 0.1 wt. % to about 5.0 wt. % of surfactant comprising a reaction product of (i) reactant A: an aliphatic polyether polyol having a weight average molecular weight of about 100 to about 4000; and (ii) reactant B: an epoxy compound having at least one epoxy group per molecule; wherein the ratio of molar equivalents of “reactant A” to molar equivalents of “reactant B” is from about 1:0.5 to about 1:4 and (iii) about 5.0 wt. % to about 85.0 wt. % of at least one film forming polymer; and (iv) about 10.0 wt. % to about 94.9 wt. %, of at least one additive.

In another aspect, the present application provides a coating composition comprising:
(I) about 0.1 wt. % to about 5.0 wt. % of a surfactant comprising: (a) a reaction product of (i) reactant A: an aliphatic polyether polyol having a weight average molecular weight of about 100 to about 4000; and (ii) reactant B: an epoxy compound having at least one epoxy group per molecule, wherein the ratio of molar equivalents of “reactant A” to molar equivalents of “reactant B” is from about 1:0.5 to about 1:4, and (b) a reaction product of (i) reactant B: an epoxy compound having at least one epoxy group per molecule; and (ii) reactant C: an aliphatic alkoxylated alcohol having a weight average molecular weight of about 100 to about 4000;
(II) about 5.0 wt. % to about 85.0 wt. % of at least one film forming polymer; and
(III) about 10.0 wt. % to about 94.9 wt. %, of at least one additive.

### DETAILED DESCRIPTION OF THE INVENTION

Before explaining at least one aspect of the disclosed and/or claimed inventive concept(s) in detail, it is to be understood that the disclosed and/or claimed inventive concept(s) is not limited in its application to the details of construction and the arrangement of the components or steps or methodologies set forth in the following description or illustrated in the drawings. The disclosed and/or claimed inventive concept(s) is capable of other aspects or of being practiced or carried out in various ways. Also, it is to be understood that the phraseology and terminology employed herein is for the purpose of description and should not be regarded as limiting.

Unless otherwise defined herein, technical terms used in connection with the disclosed and/or claimed inventive concept(s) shall have the meanings that are commonly understood by those of ordinary skill in the art. Further, unless otherwise required by context, singular terms shall include pluralities and plural terms shall include the singular.

The singular forms “a,” “an,” and “the” include plural forms unless otherwise specified or clearly implied to the contrary by the context. The terms “comprising” and “comprised of” include the more restrictive meanings “consisting essentially of” and “consisting of,”.

For purposes of the following detailed description, other than in any operating examples, or where otherwise indicated, numbers that express, for example, quantities of ingredients used in the specification and claims are to be understood as being modified in all instances by the term “about”. The numerical parameters set forth in the specification and attached claims are approximations that may vary depending upon the desired properties to be obtained in carrying out the invention.

All percentages, parts, proportions, and ratios as used herein, are by weight of the total composition, unless otherwise specified. All such weights as they pertain to listed ingredients are based on the active level and, therefore, do not include solvents or by-products that may be included in commercially available materials, unless otherwise specified.

All publications, articles, papers, patents, patent publications, and other references cited herein are incorporated herein in their entirety for all purposes to the extent consistent with the disclosure herein.

As utilized in this disclosure, the following terms, unless otherwise indicated, shall be understood to have the following meanings.

The term “at least one” will be understood to include one as well as any quantity more than one, including but not limited to, 1, 2, 3, 4, 5, 10, 15, 20, 30, 40, 50, 100, etc. The term “at least one” may extend up to 100 or 1000 or more depending on the term to which it is attached. In addition, the quantities of 100/1000 are not to be considered limiting as lower or higher limits.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

As used herein, the term “surfactant” refers to any amphipathic molecule that, when added to water, reduces the surface tension.

As used herein, the term “moiety” or “moieties” refers to a part(s) or a functional group(s) of a molecule.

The term “substituted” means that the specified group(s) or moiety or moieties bears one or more substituent.

The term “functionalized” with reference to any moiety refers to the presence of one or more functional groups in the moiety. Various functional groups may be introduced in a moiety by way of one or more functionalization reactions known to a person having ordinary skill in the art. It is to be understood that an alcohol or polyol “functionalized” by an epoxy compound or glycidyl ether has reacted so that at least one hydroxyl group of the alcohol or polyol has formed an ether bond to one of the carbon atoms of an epoxide group of the epoxy compound or glycidyl ether and so that at least one epoxide group of the epoxy compound or glycidyl ether has ring opened upon attack by the alcohol or polyol to generate a new hydroxyl group.

As used herein, the term “aliphatic polyether polyol” refers to reactant A, a polyether having two or more hydroxyl groups and having a molecular weight of about 100 to about 4000. Examples of aliphatic polyether polyols include oligomers, polymers and copolymers of ethylene oxide, propylene oxide and butylene oxide, polyethylene glycols, polypropylene glycols, poly(trimethylene oxide)glycols and polytetramethylene ether glycols. In a preferred embodiment, the aliphatic polyether polyol is a polyethylene glycol.

In one non-limiting embodiment, “aliphatic polyether polyol” refers to polyethylene glycol selected from the group consisting of PEG 100, PEG 200, PEG 300, PEG 400, PEG 500, PEG 600, PEG 700, PEG 800, PEG 900, PEG 1000, PEG 1100, PEG 1200, PEG 1300, PEG 1400, PEG 1500, PEG 1600, PEG 1700, PEG 1800, PEG 1900, PEG 2000, PEG 2100, PEG 2200, PEG 2300, PEG 2400, PEG 2500, PEG 2600, PEG 2700, PEG 2800, PEG 2900, PEG 3000, PEG 3100, PEG 3200, PEG 3300, PEG 3400, PEG 3500, PEG 3600, PEG 3700, PEG 3800, PEG 3900, and PEG 4000.

In one non-limiting embodiment, the epoxy compound used as reactant B in the claimed invention is an alkyl glycidyl ether in which the alkyl group is saturated or unsaturated, straight-chain or branched aliphatic hydrocarbyl group having from 3 to 24 carbon atoms. According to another non-limiting embodiment of the present application, the epoxy compound can be a primary straight-chain alkyl glycidyl ether, such as n-butyl glycidyl ether, n-octyl glycidyl ether, n-decyl glycidyl ether, n-dodecyl glycidyl ether, n-tetradecyl glycidyl ether, n-hexadecyl glycidyl ether, n-octadecyl glycidyl ether, n-octadecenyl glycidyl ether (oleyl glycidyl ether), docosyl glycidyl ether, and the like; a primary branched alkyl glycidyl ether, such as 2-ethylhexyl glycidyl ether, 2-hexyldecyl glycidyl ether, 2-octyldodecyl glycidyl ether, 2-heptylundecyl glycidyl ether, 2-(1,3,3-trimethylbutyl) octyl glycidyl ether, 2-decyltetradecyl glycidyl ether, 2-dodecylhexadecyl glycidyl ether, 2-tetradecyloctadecyl glycidyl ether; a secondary alkyl glycidyl ether such as sec-decyl glycidyl ether, sec-octyl glycidyl ether, sec-dodecyl glycidyl ether, and the like; or a tertiary alkyl glycidyl ether, such as t-octyl glycidyl ether, t-dodecyl glycidyl ether, and the like.

As used herein, the term “aliphatic alkoxylated alcohol” refers to a substance, reactant C, having a structure of

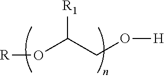

wherein R is a linear or branched alkyl group having 1 to 20 carbons; R₁=H and/or CH₃ and n=1-25.

In one non-limiting embodiment, “aliphatic alkoxylated alcohol” includes alcohol ethoxylates selected from the group consisting of C₆₋₂₀ alcohol ethoxylates (3-23 EO). Examples of such surfactants can be obtained from BASF (LUTENSOL®) and Sasol Performance Chemicals (NOVEL®).

In another non-limiting embodiment, the present application discloses a process for preparing a surfactant comprising the reaction of (i) about 1 molar equivalent of aliphatic polyether polyol and (ii) about 2 molar equivalents of alkyl glycidyl ether in the presence of about 0.05 molar equivalent of a base to form a mixture of polyol mono-functionalized by alkyl glycidyl ether and at least one polyol multi-functionalized by alkyl glycidyl ether, wherein the reaction is conducted at a temperature of from about 80° C. to about 120° C. in presence of a base selected from the group consisting of (i) amines including but not limited to triethylamine, 4-(dimethylamino)pyridine, 1,1,3,3-tetramethylguanidine and (ii) oxides, hydroxides, carbonates and bicarbonates of sodium, potassium, calcium, and combinations thereof.

In another non-limiting embodiment, the present application discloses reaction of (i) a polyethylene glycol and (ii) 2-ethylhexyl glycidyl ether, wherein the ratio of molar equivalents of polyethylene glycol to molar equivalents of 2-ethylhexyl glycidyl ether is from about 1:0.5 to about 1:4.

In another non-limiting embodiment, the present application discloses a process for preparing a surfactant comprising the reaction of (i) about 1 molar equivalent of aliphatic polyether polyol and (ii) about 2 molar equivalents of epoxy compound in the presence of about 0.05 molar equivalent of a base to form a mixture of polyol mono-functionalized by epoxy compound and at least one polyol multi-functionalized by epoxy compound in the presence of about 0.05 molar equivalent of a base, wherein the reaction is conducted at a temperature of from about 80° C. to about 120° C. in presence of a base selected from the group consisting of (i) amines including but not limited to triethylamine, 4-(dimethylamino)pyridine, and 1,1,3,3-tetramethylguanidine; and (ii) oxides, hydroxides, carbonates and bicarbonates of sodium, potassium, calcium, and combinations thereof.

In another non-limiting embodiment, the present application discloses a ratio of molar equivalents of polyethylene glycol to molar equivalents of 2-ethylhexyl glycidyl ether from about 1:0.5 to about 1:4.

In another embodiment, the present application discloses a surfactant that comprises polyol mono-functionalized by alkyl glycidyl ether, present in an amount from about 0.05% to about 0.5%; or from about 0.5 wt. % to about 1 wt. %; or from about 1 wt. % to about 2.5 wt. %; or from about 2.5 wt. % to about 5 wt. %; or from about 5 wt. % to about 10 wt. %; or from about 10 wt. % to about 15 wt. %; or from about 15 wt. % to about 20 wt. %; or from about 20 wt. % to about 25 wt. %; or from about 25 wt. % to about 30 wt. %; or from about 30 wt. % to about 35 wt. %; or from about 35 wt. % to about 40 wt. %; and that comprises polyol multi-functionalized by alkyl glycidyl ether, present in an amount of from about 60 wt. % to about 65 wt. %; or from about 65 wt. % to about 70 wt. %; or from about 70 wt. % to about 75 wt. %; or from about 75 wt. % to about 80 wt. %; or from about 80 wt. % to about 85 wt. %; or from about 85 wt. % to about 90 wt. %; or from about 90 wt. % to about 95 wt. %; or from about 95 wt. % to about 99.5 wt. %.

In one embodiment, the present application discloses a surfactant comprising a reaction product of (i) reactant A: polyethylene glycol (PEG) having a weight average molecular weight of about 100 to about 4000; and (ii) reactant B: 2-ethylhexyl glycidyl ether (EHGE), wherein 1 molar equivalent of PEG reacts with 2 molar equivalents of EHGE to form a mixture of PEG mono-functionalized by EHGE, PEG di-functionalized by EHGE, PEG tri-functionalized by EHGE, PEG tetra-functionalized by EHGE, and PEG penta-functionalized by EHGE and having a generic structure of:

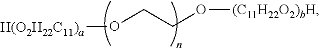

wherein each C₁₁H₂₂O₂ unit is independently

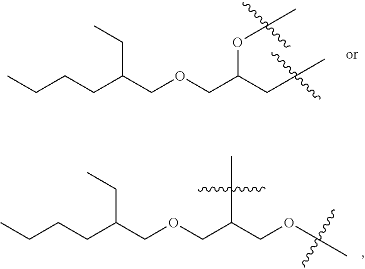 [SMILES: *CC(COCC(CC)CCCC)O* ; *OCC(*)COCC(CC)CCCC]

wherein each C₁₁H₂₂O₂ unit is attached to the polyethylene glycol core or another C₁₁H₂₂O₂ unit by a carbon-oxygen single bond; and wherein n=2 to 90 and a+b=1 to 5 comprising PEG mono-functionalized by EHGE, having a+b=1; PEG di-functionalized by EHGE, having a+b=2; PEG tri-functionalized by EHGE, having a+b=3; PEG tetra-functionalized by EHGE, having a+b=4; and PEG penta-functionalized by EHGE, having a+b=5.

In another embodiment, the present application provides a surfactant that comprises a reaction product of: (i) aliphatic alkoxylated alcohol R—(OCH₂CHR₁)ₙ—OH; and (ii) 2-ethylhexyl glycidyl ether (EHGE); wherein 1 molar equivalent of aliphatic alkoxylated alcohol reacts with 1 molar equivalents of EHGE to form a mixture of aliphatic alkoxylated alcohol mono-functionalized by EHGE, aliphatic alkoxylated alcohol di-functionalized by EHGE, aliphatic alkoxylated alcohol tri-functionalized by EHGE, aliphatic alkoxylated alcohol tetra-functionalized by EHGE, and aliphatic alkoxylated alcohol penta-functionalized by EHGE and having a generic structure of:

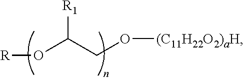

wherein each C₁₁H₂₂O₂ unit is independently

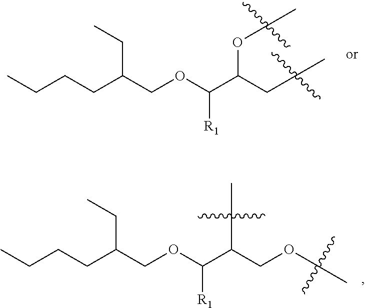

wherein each C₁₁H₂₂O₂ unit is attached to the polyethylene glycol core or another C₁₁H₂₂O₂ unit by a carbon-oxygen single bond; and
wherein R=a linear or branched alkyl group having 1 to 20 carbons, R₁=H and/or CH₃, and n=1 to 25;
wherein a=1 to 5, comprising
aliphatic alkoxylated alcohol mono-functionalized by EHGE, having a=1;
aliphatic alkoxylated alcohol di-functionalized by EHGE, having a=2;
aliphatic alkoxylated alcohol tri-functionalized by EHGE, having a=3;
aliphatic alkoxylated alcohol tetra-functionalized by EHGE, having a=4; and
aliphatic alkoxylated alcohol penta-functionalized by EHGE, having a=5.

In one embodiment, the present application provides a composition comprising (i) about 5.0 wt. % to about 99.5 wt. % of surfactant comprising a reaction product of (i) reactant A: an aliphatic polyether polyol having a weight average molecular weight of about 100 to about 4000; and (ii) reactant B: an epoxy compound having at least one epoxy group per molecule; wherein the ratio of molar equivalents of “reactant A” to molar equivalents of “reactant B” is from about 1:0.5 to about 1:4 and (iii) about 0.5 wt. % to about 95.0 wt. % of at least one additive.

In one embodiment, the present application provides a composition comprising (i) about 5.0 wt. % to about 99.5 wt. % of a surfactant comprising:
(a) a reaction product of (i) reactant A: an aliphatic polyether polyol having a weight average molecular weight of about 100 to about 4000; and (ii) reactant B: an epoxy compound having at least one epoxy group per molecule, wherein the ratio of molar equivalents of “reactant A” to molar equivalents of “reactant B” is from about 1:0.5 to about 1:4, and wherein the surfactant further comprises a reaction product of (i) reactant B: an epoxy compound having at least one epoxy group per molecule; and (ii) reactant C: an aliphatic alkoxylated alcohol having a weight average molecular of about 100 to about 4000; and
(b) about 0.5 wt. % to about 95.0 wt. % of at least one additive.

In another embodiment, the present application discloses a coating composition comprising (i) about 0.1 wt. % to about 5.0 wt. % of surfactant comprising a reaction product of (a) reactant A: an aliphatic polyether polyol having a weight average molecular weight of about 100 to about 4000; and (b) reactant B: an epoxy compound having at least one epoxy group per molecule; wherein the ratio of molar equivalents of “reactant A” to molar equivalents of “reactant B” is from about 1:0.5 to about 1:4; (ii) about 5.0 wt. % to about 85.0 wt. % of at least one film forming polymer; and (iii) about 10.0 wt. % to about 94.9 wt. %, of at least one additive.

In one embodiment, the present application discloses a coating composition comprising: (I) about 0.1 wt. % to about 5.0 wt. % of a surfactant comprising: (a) a reaction product of (i) reactant A: an aliphatic polyether polyol having a weight average molecular weight of about 100 to about 4000; and (ii) reactant B: an epoxy compound having at least one epoxy group per molecule, wherein the ratio of molar equivalents of “reactant A” to molar equivalents of “reactant B” is from about 1:0.5 to about 1:4, and (b) a reaction product of (i) reactant B: an epoxy compound having at least one epoxy group per molecule; and (ii) reactant C: an aliphatic alkoxylated alcohol having a weight average molecular weight of about 100 to about 4000;
(II) about 5.0 wt. % to about 85.0 wt. % of at least one film forming polymer; and
(III) about 10.0 wt. % to about 94.9 wt. %, of at least one additive.

According to another embodiment of the present application, the composition comprising surfactant of the claimed invention is used in various coatings applications including but not limited to paper products, metal coatings, architectural coatings, graphic arts, fibrous materials, films, sheets, composites, printing inks, inkjet printing, flock and other adhesives, hair care products, skin care products, nail care products, house-hold products, livestock/agriculture, wood coatings, textile products, nonwoven coatings, and seed applications.

In one embodiment, the present application discloses a composition comprising at least one additive that is selected from the group consisting of coalescent agents, film-forming agents, emulsifiers, stabilizers, rheology modifiers, cosolvents, dispersing agents, defoamers, wet-edge additives, wetting agents, humectants, wax, colorants, thickeners, anticaking agents, antifoaming agents, UV absorbers, pigments, antifreeze agents, gel inhibitors, preservatives, hydrophobic agents, adhesion promoters, biocides, anti-oxidants and plasticizers.

In another embodiment, the present application discloses that the molecular weight of the aliphatic alkoxylated alcohol is in the range of from about 100 to about 4000 Daltons. In some embodiments, the molecular weight of the aliphatic alkoxylated alcohol is in the range of from about 100 to about 200 Daltons; or from about 200 to about 300 Daltons; or from about 300 to about 400 Daltons; or from about 400 to about 500 Daltons; or from about 500 to about 600 Daltons; or from about 600 to about 700 Daltons; or from about 700 to about 800 Daltons; or from about 800 to about 900 Daltons; or from about 900 to about 1000 Daltons; or from about 1000 to about 1500 Daltons; or from about 1500 to about 2000 Daltons; or from about 2000 to about 2500 Daltons; or from about 2500 to about 3000 Daltons; or from about 3000 to about 3500 Daltons; or from about 3500 to about 4000 Daltons.

In another embodiment, the present application discloses that the composition comprising surfactant is present in an amount from about 5 wt. % to about 10 wt. %; or from about 10 wt. % to about 15 wt. %; or from about 15 wt. % to about 20 wt. %; or from about 20 wt. % to about 25 wt. %; or from about 25 wt. % to about 30 wt. %; or from about 30 wt. % to about 35 wt. %; or from about 35 wt. % to about 40 wt. %; or from about 40 wt. % to about 45 wt. %; or from about 45 wt. % to about 50 wt. %; or from about 50 wt. % to about 55 wt. %; or from about 55 wt. % to about 60 wt. %; or from about 60 wt. % to about 65 wt. %; or from about 65 wt. % to about 70 wt. %; or from about 70 wt. % to about 75 wt. %; or from about 75 wt. % to about 80 wt. %; or from about 80 wt. % to about 85 wt. %; or from about 85 wt. % to about 90 wt. %; or from about 90 wt. % to about 95 wt. %; or from about 95 wt. % to about 99.5 wt. %

In another embodiment, the present application discloses that, in a composition comprising one or more additive, the additive is present in an amount of from about 0.5 wt. % to about 1 wt. %; or from about 1 wt. % to about 2.5 wt. %; or from about 2.5 wt. % to about 5 wt. %; or from about 5 wt. % to about 10 wt. %; or from about 10 wt. % to about 15 wt. %; or from about 15 wt. % to about 20 wt. %; or from about 20 wt. % to about 25 wt. %; or from about 25 wt. % to about 30 wt. %; or from about 30 wt. % to about 35 wt. %; or from about 35 wt. % to about 40 wt. %; or from about 40 wt. % to about 45 wt. %; or from about 45 wt. % to about 50 wt. %; or from about 50 wt. % to about 55 wt. %; or from about 55 wt. % to about 60 wt. %; or from about 60 wt. % to about 65 wt. %; or from about 65 wt. % to about 70 wt. %; or from about 70 wt. % to about 75 wt. %; or from about 75 wt. % to about 80 wt. %; or from about 80 wt. % to about 85 wt. %; or from about 85 wt. % to about 90 wt. %; or from about 90 wt. % to about 95 wt. % based on the total weight of the composition.

In another embodiment, the present application discloses that the coating composition comprising surfactant is present in an amount of from about 0.1 wt. % to about 0.2 wt. %; or from about 0.2 wt. % to about 0.3 wt. %; or from about 0.3 wt. % to about 0.4 wt. %; or from about 0.4 wt. % to about 0.5 wt. %; from about 0.5 wt. % to about 0.6 wt. %; from about 0.6 wt. % to about 0.7 wt. %; from about 0.7 wt. % to about 0.8 wt. %; from about 0.8 wt. % to about 0.9 wt. %; from about 0.9 wt. % to about 1.0 wt. %; about 1.0 wt. % to about 2 wt. %; or from about 2.0 wt. % to about 3.0 wt. %; about 3.0 wt. % to about 4.0 wt. %; or from about 4.0 wt. % to about 5.0 wt. %; based on the total weight of the composition.

In another non-limiting embodiment, the present application discloses that the coating composition comprises a film forming polymer in an amount of from about 5 wt. % to about 10 wt. %; from about 10 wt. % to about 15 wt. %; or from about 15 wt. % to about 20 wt. %; or from about 20 wt. % to about 25 wt. %; or from about 25 wt. % to about 30 wt. %; or from about 30 wt. % to about 35 wt. %; or from about 35 wt. % to about 40 wt. %; or from about 40 wt. % to about 45 wt. %; or from about 45 wt. % to about 50 wt. %; or from about 50 wt. % to about 55 wt. %; or from about 55 wt. % to about 60 wt. %; or from about 60 wt. % to about 65 wt. %; or from about 65 wt. % to about 70 wt. %; or from about 70 wt. % to about 75 wt. %; or from about 75 wt. % to about 80 wt. %; or from about 80 wt. % to about 85 wt. % based on the total weight of the coating composition.

In another embodiment, the present application discloses the coating composition comprising one or more additives is present in an amount of from about 10 wt. % to about 15 wt. %; or from about 15 wt. % to about 20 wt. %; or from about 20 wt. % to about 25 wt. %; or from about 25 wt. % to about 30 wt. %; or from about 30 wt. % to about 35 wt. %; or from about 35 wt. % to about 40 wt. %; or from about 40 wt. % to about 45 wt. %; or from about 45 wt. % to about 50 wt. %; or from about 50 wt. % to about 55 wt. %; or from about 55 wt. % to about 60 wt. %; or from about 60 wt. % to about 65 wt. %; or from about 65 wt. % to about 70 wt. %; or from about 70 wt. % to about 75 wt. %; or from about 75 wt. % to about 80 wt. % or from about 80 wt. % to about 85 wt. %; or from about 85 wt. % to about 90 wt. %; or from about 90 wt. % to about 94.9 wt. % based on the total weight of the coating composition.

In another embodiment of the present application, the coating composition comprising coalescing agents can include, but are not limited to ester alcohols, benzoate ethers, glycol ethers, glycol ether esters and n-methyl-2-pyrrolidone.

In another embodiment of the present application, the composition comprising emulsifiers are selected from anionic emulsifiers, such as mono-, di- or triethanolamine oleate, stearate, diethylethanolamine oleate, stearate, 2-amino 2-methylpropan-1-ol stearate), sulfonated compounds (for example, sodium dodecylsulfate, turkey red oil, etc.) and sulfonated compounds (eg., sodium cetylsulfonate), cationic emulsifiers such as quaternary ammonium compounds (for example, cetyl trimethyl ammonium bromide, benzyl lauryl dimethylammonium chloride, etc.), amphoteric emulsifiers (eg. lecithins) and nonionic emulsifiers, such as fatty alcohols (lauryl, cetyl, stearyl or palmityl alcohol), partial fatty acid esters of polyhydric alcohols with saturated fatty acids (glycerol monostearate, pentaerythritol monostearate, ethylene glycol monostearate, propylene glycol monostearate), partial fatty acid esters of polyhydric alcohols with unsaturated fatty acids (for example glycerol monooleate, pentaerythritol monooleate), polyoxyethylene esters of fatty acids (eg. polyoxyethylene stearate), polymerization products of ethylene oxide and propylene oxide with fatty alcohols (fatty alcohol polyglycol ethers) or fatty acids (fatty acid ethoxylates),

In one embodiment, the present application discloses a composition comprising suitable rheology modifiers to control viscosity over a wide shear rate range. Moreover, the coating compounds contain rheology modifiers such as fine-particle silica, layered silicates, or polymeric cellulosics, and nonionic synthetic associative thickeners (NSAT's) compounds.

Suitable dispersants employed in the composition include but are not limited to non-ionic, anionic and cationic dispersants such as 2-amino 2-methyl 1-propanol (AMP), dimethyl amino ethanol (DMAE), potassium tripolyphosphate (KTPP), trisodium polyphosphate (TSPP), citric acid and other carboxylic acids, and the like. Also, suitable dispersants for the present composition are anionic polymers such as homopolymers and copolymers based on polycarboxylic acids, including those that are hydrophobically-modified e.g., polyacrylic acid or polymethacrylic acid or maleic anhydride with monomers such as styrene, acrylate or methacrylate, isobutylene, and other hydrophilic or hydrophobic comonomers as well as the salts of the aforementioned dispersants, and mixtures thereof.

To prevent evaporation of the water in the composition before the coating has fully dried suitable humectants can be added. Examples of such humectants are ethylene glycol, glymes and polyethylene glycol.

Suitable defoamers in the composition can include silicone-based and mineral oil-based defoamers, and the like.

In another embodiment of the present application, composition comprising anti-foaming agent can include, but are not limited to animal and plant oil type anti-foaming agent, a fatty acid type anti-foaming agent, a nonionic anti-foaming agent (polyether anti-foaming agent), an acetylene diol anti-foaming agent, a fluorine anti-foaming agent, a silicone anti-foaming agent, a mineral oil anti-foaming agent, a phosphoric acid ester anti-foaming agent.

In another embodiment of the present application, thickeners are added to compositions to achieve the desired viscosity and flow properties. Thickeners can include but are not limited to cellulose derivatives including hydroxyethyl cellulose, methyl cellulose and carboxymethyl cellulose, and may be used in the compositions.

Suitable thickeners can include, but are not limited to polyvinyl alcohol (PVA), hydrophobically-modified, alkali-soluble emulsions known in the art as HASE emulsions, alkali-soluble or alkali-swellable emulsions known in the art as ASE emulsion, hydrophobically-modified ethylene oxide-urethane polymers known in the art as HEUR thickeners; and cellulosic thickeners such as hydroxymethyl cellulose (HMC), hydroxyethyl cellulose (HEC), hydrophobically-modified hydroxy ethyl cellulose (HMHEC), sodium carboxymethyl cellulose (SCMC), sodium carboxymethyl 2-hydroxyethyl cellulose, 2-hydroxypropyl methyl cellulose, 2-hydroxyethyl methyl cellulose, 2-hydroxybutyl methyl cellulose, 2-hydroxyethyl ethyl cellulose, 2-hydoxypropyl cellulose, and the like. Also useful as thickeners are fumed silica, attapulgite clay and other types of clay, titanate chelating agents, and the like.

“Antifreeze agent” refers to additives which prevent freezing. Suitable antifreeze agents can include, but are not limited to alcohols, polyols such as glycerol, glycols such as propylene glycol and polyol fatty acid esters, or their derivatives.

One or more preservatives may be added in the compositions in low doses to protect against the growth of micro-organisms. Preservatives can include but are not limited to 2-meth-4-isothiazolin-3-one (MIT), 1,2-Benzisothiazolin-3-one (BIT), 5-Chloro-2-methyl-4-isothiazolin-3-one (CMIT), 2-Octyl-4-isothiazolin-3-one (Off) 3-Iodo-2-propynylbutyl carbamate (IPBC), oxyfluorfen, thiabendazole, terbutryn, zinc pyrithione (ZnPy) and suitable mildewcides and biocides in the composition include zinc oxide, isothiazolones, triazoles.

In another embodiment of the present application, suitable latex adhesion promoters in the composition include, but are not limited to, homopolymers, copolymers or terpolymers such as, for example, acrylic and or methacrylic, polymers or copolymers, polyvinyl acetate, styrene-acrylic copolymers, styrene-butadiene copolymers, vinyl acetate-acrylic copolymers, ethylene-vinyl acetate copolymers, vinyl acetate-vinyl versatate copolymers, vinyl acetate-vinyl maleate copolymers, vinyl acetate-vinyl chloride-acrylic terpolymers, ethylene-vinyl acetate-acrylic terpolymer, and urethane polymers. The polymers may contain up to about 10% by weight of monomers containing functional groups, for example, but not limited to, carboxylic acid, phosphate, sulfate, sulfonate and amide groups, other monomers, and mixtures thereof.

The composition of the present disclosure can further include at least one pigment. The pigment can be selected from the group consisting of phthalocyanines, iron oxides, titanium dioxides, zinc oxide, indigo, hydrated aluminum oxide, barium sulfate, calcium silicate, clay, silica, talc, calcium carbonate, and mixtures thereof. Titanium dioxide grades used in the composition are surface modified with various inorganic oxides, such as silicates, aluminates, and zirconates. Aluminum silicate, nepeline syenite, mica, calcium carbonate, and/or diatomaceous earth can also be employed.

The composition of the present disclosure can further include at least one film forming polymer. The film forming polymer of the present disclosure can be selected from a wide variety of polymers known in the related art. For instance, these film forming polymers can be derived from various ethylenically unsaturated monomers such as ethylene, vinyl and acrylic monomers. Examples of such monomers can include, but are not limited to, acrylic acid, methacrylic acid, methacrylic acid esters, styrene, α-methyl styrene, vinyl chloride, acrylonitrile, methacrylonitrile, ureido methacrylate, vinyl acetate, vinyl esters of branched tertiary monocarboxylic acids, itaconic acid, crotonic acid, maleic acid, fumaric acid, and ethylene. It is also possible to include C₄-C₈ conjugated dienes such as 1,3-butadiene, isoprene and chloroprene. The film forming polymers can also be copolymerized products of more than one monomer to achieve several desired properties, particularly for applications in latex paints with very little or no volatile organic compounds (VOCs). Examples of suitable film forming polymers can include, but are not limited to, homo- or co-polymers of vinyl acetate, methacrylic acid, methylacrylate, methylmethacrylate, ethylacrylate, butyl acrylate, styrene, ethylene, vinyl chloride, vinyl ester of neodecanoic acid, vinyl propionate, butadiene, acrylonitrile, maleates, and fumarates. In one non-limiting embodiment of the present disclosure, the film forming polymer is selected from the group consisting of acrylics, vinyl-acrylics and styrene-acrylics, styrene-butadiene copolymers, vinyl acetate ethylenes, butadiene-acrylonitrile copolymers, polyepoxides, polyurethanes, polyamides, vinyl esters of neodecanoic acid and polyesters.

Examples of other suitable film forming polymers can include, but are not limited to, alkyds, cellulosics (cellulose nitrate and cellulose esters), coumarone-indenes, epoxies, esters, hydrocarbons, melamines, natural resins, oleo resins, phenolics, polyamides, polyesters, rosins, silicones, terpenes, urea, and urethanes.

Additives in minor amounts, i.e., less than about 10% by weight, based on the total weight of the composition, can be included. Such additives include cosolvents, wet-edge additives, wetting agents, wax, colorants, anticaking agents, UV absorbers, gel inhibitors, hydrophobic agents, and antioxidants.

In one embodiment, the present application discloses a coating composition used for lacquer coating, primer coating, ink jet printing, top coating, varnish coating, architectural coating, wood coating, printing inks and metallic or non-metallic coating.

The coating composition in the form of a paint can include enamels, lacquers, varnishes, undercoats, primers, seals, fillers, stoppers, and the like.

In one embodiment, the present application discloses a coating composition coated on a substrate selected from the group consisting of porous and non-porous substrates, papers, non-woven materials, textiles, leather, wood, concrete, masonry, metals, non-metals, house wrap, building materials, fiberglass, polymeric articles, face masks, medical drapes and gowns, carpets, upholstery, tents, awnings, air bags, fabrics, ceramics, yarns, and blends, woven, non-woven, knitted, natural, synthetic, and regenerated substrates.

Further, certain aspects of the present application are illustrated in detail by way of the following examples. The examples are given herein for illustration of the application and are not intended to be limiting thereof.

### Examples

The synthetic scheme reaction of PEG and EHGE

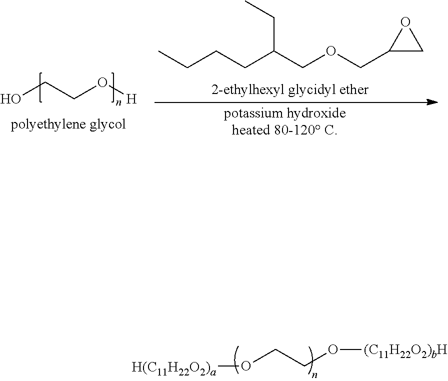

wherein each C₁₁H₂₂O₂ unit is independently

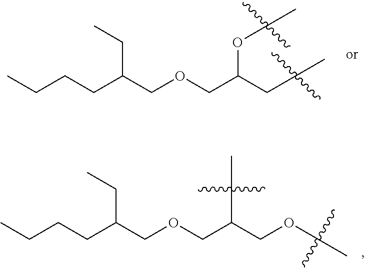 [SMILES: *CC(COCC(CC)CCCC)O* ; *OCC(*)COCC(CC)CCCC]

and wherein each C₁₁H₂₂O₂ unit is attached to the polyethylene glycol core or another C₁₁H₂₂O₂ unit by a carbon-oxygen single bond, and wherein a+b=1 to 5 and n=2 to 90;
For the monosubstituted surfactant adduct, a+b=1.
For the disubstituted surfactant adduct, a+b=2.
For the trisubstituted surfactant adduct, a+b=3.
For the tetrasubstituted surfactant adduct, a+b=4.
For the pentasubstituted surfactant adduct, a+b=5.

Experimental Procedure 1 (batch procedure): The reaction of PEG and EHGE was run using the following one-pot procedure: Polyethylene glycol, 2-ethylhexyl glycidyl ether, and potassium hydroxide were combined in a vessel, which was sealed and maintained under a nitrogen atmosphere. The reaction mixture was stirred and heated to 100° C. for 7-19 hours and then cooled to room temperature. The following examples were run using this procedure.

Example 1: The reaction of PEG 400 (28.50 g), 2-ethylhexyl glycidyl ether (6.64 g), and potassium hydroxide (200 mg) was run for 19 hours at 100° C. following Experimental Procedure 1.

Example 2: The reaction of PEG 400 (11.00 g), 2-ethylhexyl glycidyl ether (20.49 g), and potassium hydroxide (77 mg) was run for 19 hours at 100° C. following Experimental Procedure 1.

Example 4: The reaction of PEG 300 (111.51 g), 2-ethylhexyl glycidyl ether (138.49 g), and potassium hydroxide (1.043 g) was run for 7 hours at 100° C. following Experimental Procedure 1.

Experimental Procedure 2 (slow addition procedure): The reaction of PEG and EHGE was run using the following slow-addition procedure: Polyethylene glycol and potassium hydroxide were combined in a vessel, which was sealed and maintained under nitrogen atmosphere. The reaction mixture was stirred and heated to 100° C. Once temperature reached 100° C., 2-ethylhexyl glycidyl ether was slowly added over ~1 hour. The reaction mixture was stirred at 100° C. for 30 minutes and then at 120° C. for 3 to 3.5 hours and then cooled to room temperature. The following examples were run using this procedure.

Example 3: The reaction of PEG 200 (87.00 g), 2-ethylhexyl glycidyl ether (162.07 g), and potassium hydroxide (1.22 g) was run following Experimental Procedure 2.

Example 5: The reaction of PEG 400 (520.00 g), 2-ethylhexyl glycidyl ether (484.35 g), and potassium hydroxide (3.65 g) was run following Experimental Procedure 2.

Example 6: The reaction of PEG 600 (160.00 g), 2-ethylhexyl glycidyl ether (99.35 g), and potassium hydroxide (748 mg) was run following Experimental Procedure 2.

Example 7: The reaction of PEG 1000 (190.00 g), 2-ethylhexyl glycidyl ether (70.79 g), and potassium hydroxide (533 mg) was run following Experimental Procedure 2.

Example 8: The reaction of PEG 2000 (210.50 g), 2-ethylhexyl glycidyl ether (39.21 g), and potassium hydroxide (398 mg) was run following Experimental Procedure 2.

Example 9: The reaction of PEG 4000 (228.50 g), 2-ethylhexyl glycidyl ether (21.28 g), and potassium hydroxide (396 mg) was run following Experimental Procedure 2.

LCMS: LCMS was used to separate mixtures of substituted PEGs, and to determine the relative abundance of PEGs with varying degrees of substitution. Peaks corresponding to unsubstituted PEG, monosubstituted PEG, disubstituted PEG, trisubstituted PEG and tetrasubstituted PEG were well resolved by HPLC and were thus reliably integrated.

Procedure: About 0.1 g of each sample was combined with 10 mL of methanol and vortexed until the resulting stock solution was homogenous. For LCMS analysis, 100 μL of stock solution was diluted with 900 μL of methanol, and the resulting solution was injected directly into the system. LCMS analyses were performed on an Agilent 6520 QTOF LC/MS with Agilent 1260 HPLC and MassHunter software.

### HPLC Conditions:

| Column | Agilent Poroshell-120 SB-C18 2.1 × 75 mm, 2.7 μm | | |
|---|---|---|---|
| Mobile phase A | 10 mM ammonium acetate in water | | |
| Mobile phase B | 10 mM ammonium acetate in methanol | | |
| | Time (min) | % A | % B |
| Gradient | 0 | 90 | 10 |
| | 50 | 0 | 100 |
| | 60 | 90 | 10 |

| | |
|---|---|
| Post run time | 15 min |
| Flow rate | 0.25 mL/min |
| Column temperature | 40° C. |
| Injection volume | 2 μL |

### MS Conditions:

| Ion source | ESI | |
|---|---|---|
| Polarity | Positive | |
| Acquisition mode | MS1 | |
| Drying gas temperature | 300° | C. |
| Drying gas flow | 10 | L/min |
| Fragmentor | 100 | V |
| Nebulizer | 40 | psig |
| Capillary voltage | 4000 | V |

| | |
|---|---|
| Start mass | 75 |
| End mass | 1500 |

Table 1 lists the product distributions determined for the reaction products of Examples 1-7.

TABLE 1
Product Distribution of Substituted
PEGs Determined by LCMS, Area %

| Example | un- | mono- | di- | tri- | tetra- |
|---|---|---|---|---|---|
| No. | substituted | substituted | substituted | substituted | substituted |
| 1 | 35 | 48 | 15 | 2 | 0 |
| 2 | 0 | 4 | 30 | 54 | 12 |
| 3 | 1 | 28 | 39 | 31 | 0 |
| 4 | 3 | 33 | 36 | 28 | 0 |
| 5 | 5 | 37 | 29 | 20 | 10 |
| 6 | 5 | 33 | 30 | 23 | 10 |
| 7 | 9.9 | 38.4 | 26.7 | 17.1 | 7.9 |

Contact angle, static and dynamic surface tension, and foaming measurements of surfactants:

Solution Preparation: Aqueous solutions of surfactants were prepared by combining 1 g of adduct with 1000 g of DI water (filtered by Millipore-Q, pH 6.3 to 6.7) at room temperature. The resulting solution was mixed using magnetic stirrer for 24 hours before further measurement. The solution pH values for select samples were measured to be around 7.4.

Contact angle measurements: Clear, self-adhesive, 0.002-inch-thick polypropylene film (McMaster-Carr #5577149-01) was used as the substrate to measure the contact angle of 0.1 wt % aqueous solutions of surfactants.

Drop Shape Analysis System DSA 305 from Kruss was used to determine contact angle values between a sample drop and polypropylene surface. Sample drops were dispensed automatically using a disposable 1-mL syringe. The contact angle of each drop was determined automatically by the instrument fitting model software (Kruss Advance Drop Shape V 1.5.1) and recorded every second over a 30-second period. Multiple drops were placed at sufficient distances on the pre-cleaned polypropylene surface, and results are reported as average values. At least 6 drops were analyzed for each sample. All measurements were carried out at ambient temperature and relative humidity.

Static surface tension measurements: Static surface tension values of freshly mixed 0.1 wt % aqueous solutions of surfactants were measured at room temperature using force tensiometry (Attension, Biolin Scientific) with Wilhelmy Plate method based on the instrument company recommendations (in compliance with ASTM D1331-20). Three surface tension measurements were recorded for each sample, and average values are reported. The Wilhelmy plate was rinsed and pyrolyzed with flame before every measurement. Calibration of the equipment was checked by measuring the surface tension of DI water at the beginning of measurements.

Dynamic surface tension measurements: A bubble pressure tensiometer (Kruss, model BP2) was used to measure the dynamic surface tension of freshly mixed 0.1 wt % aqueous solutions of surfactants between 10 and 100,000 millisecond surface age, utilizing a 0.256 mm-diameter, hydrophobically coated, glass capillary. The capillary was cleaned between samples with detergent solution and rinsed with DI water before drying with Kimwipes. Calibration of the equipment was checked by measuring the surface tension of DI water before experimental measurements.

Foaming index determination: A SITA Messtechnik foam tester R—2000 was used to evaluate foaming behavior of the surfactants. Approximately 900 mL of freshly mixed 0.1 wt % solution was filled in the instrument reservoir and the test parameters were entered using the instrument software. Each sample was tested 3 times at room temperature. For foam build up, 250 mL of solution was filled in the cylindrical glass vessel and mixed with a bottom propeller for 10 seconds at 800 rpm. After mixing cycle, the foam height formed above the liquid was measured by the conductive probes of the instrument and foam volume was recorded in mL by the instrument software. This step was repeated 30 times and cumulative foam build-up was recorded for 30 consecutive mixing steps. After completing three runs for each sample, the average foam volume for each mixing step was calculated. The foaming index is defined as the total foam volume at the end of 30-mixing steps and was calculated by summing the average values of foam volumes for each mixing step using Excel software (Table 2).

TABLE 2
Contact Angle, Static and Dynamic Surface Tension, and Foaming Measurements

| | Static | | Contact | | Dynamic | Dynamic | Dynamic |
|---|---|---|---|---|---|---|---|
| | Surface | | Angle on | Contact | Surface | Surface | Surface |
| | Tension | | PP at | Angle on | Tension @ | Tension @ | Tension @ |
| | (dynes/ | Foaming | 30 s | PP at 0 s | 50 | 5,000 ms | 100,000 ms |
| Example No. | cm) | Index | (deg.) | (deg.) | ms(dynes/cm) | (dynes/cm) | (dynes/cm) |
| 1 | 27 | 134 | 39 | 52 | 57 | 37 | 29 |
| 2 | 27 | 0.2 | 42 | 53 | 62.4 | 27.8 | 27.4 |
| 3 | 28 | 1 | 42 | 52 | 60 | 31 | 28.5 |
| 4 | 28 | 10 | 36 | 46 | 55.7 | 28.2 | 28.7 |
| 5 | 28 | 13 | 37 | 48 | 52 | 31.3 | 29.7 |
| 6 | 28 | 34 | 41 | 52 | 47.3 | 32.9 | 29.7 |
| 7 | 27 | 66 | 39 | 51 | 50.9 | 30.3 | 27.6 |
| 8 | 29 | 141 | 54 | 64 | 56 | 43 | 35 |
| 9 | 33 | 144 | 64 | 71 | 59 | 50 | 43 |
| Control C1- | 26 | 129 | 32 | 46 | 36 | 27 | 27 |
| Lutensol ® XP80 | | | | | | | |
| Control C2- | 30 | 145 | 48 | 59 | 50 | 41 | 35 |
| Novel ® 8-7 | | | | | | | |
| Ethoxylate | | | | | | | |

*PP = Polypropylene

The binder resins shown in Table 3 were used to prepare the coating formulations. Binder #3 was prepared by diluting Neocryl XK-98 with DI water to achieve a solids level of 33%.

TABLE 3
Binder resins used in coating formulation

| | | | % |
|---|---|---|---|
| Binder # | Binder polymer resin | Description | Solids |
| 1 | Neopac ™ E-180 | Aqueous Urethane acrylic | 33 |
| | | copolymer dispersion | |
| 2 | Neocryl ™ XK-98 | Aqueous Acrylic dispersion | 44 |
| 3 | Neocryl ™ XK-98 | Aqueous Acrylic dispersion | 33 |
| | diluted | | |

Neopac ™ E-180 is a solvent-free aromatic urethane acrylic dispersion recommended for floor coatings supplied by DSM Coating Resins
Neocryl ™ XK-98 is a self-crosslinking acrylic copolymer emulsion supplied by DSM Coating Resins

A coating formulation consisting of binder resin, a co-solvent butyl carbitol (BC) and a transparent red iron oxide pigment dispersion (Disperfin® WD 400 from Rockwood pigments, Germany) was prepared using Red Devil™ mixing equipment. The Brookfield viscosities of each coating formulation were measured at 25° C. on a Brookfield DV3T instrument using spindle #2 at 200 rpm. The formulation details and the Brookfield Viscosities are reported in Table 4.

TABLE 4
Brookfield viscosities of coating formulations

| | | Brookfield |
|---|---|---|
| Coating | | Viscosity |
| formulation | | @200 rpm #2 |
| Designation | Formulation Details | (m · Pa · s) |
| Formulation A | Neopac ™ E180 + 2% BC + | 141 |
| | 0.5% Disperfin ® WD 400 | |
| Formulation B | Neocryl ™ XK-98 + 2% BC + | 129 |
| | 0.5% Disperfin ® WD 400 | |
| Formulation C | Diluted Neocryl ™XK-98 + 2% | 42 |
| | BC + 0.5% Disperfin ® WD 400 | |

Test methods for evaluating surfactant examples: The following test methods were utilized to test each surfactant example in coating formulations.

Foaming evaluation: Foamability of surfactant examples in coating formulation was measured by mixing 0.2 wt % of surfactant in each coating formulation in a 4-ounce glass jar using a Red Devil™ 5400 paint mixer for five minutes. The initial height of the liquid before mixing and final height of the liquid plus foam immediately after mixing were marked on the glass jar. The foam height was determined as the difference between final height and initial height.

Wetting performance evaluation: Wetting performance was evaluated by applying each coating formulation on a sealed Leneta™ chart (WB form B #5127) using a draw-down applicator supplied by BYK-Gardner company. A new method was developed by drawing down a thin film of 25 microns wet film thickness (WFT) in comparison to 100-micron WFT generally used in the industry to better differentiate between samples. Using this new approach, better differentiation was observed between the surfactant samples, helping to establish a structure-property relationship. The wetting performance was visually rated for pinholes, cratering and other coating defects. A rating scale from 1 to 5 was recorded for each drawdown; For example, a rating of 1 was recorded for the least wetting surfactant example and a rating of 5 was recorded for the best wetting surfactant example.

Surfactant performance results: Table 5 gives the foam height of example surfactants at 0.2 wt % surfactant solids in coating formulation A, formulation B and formulation C and Table 6 gives the application performance in terms of substrate wetting visual rating.

TABLE 5
Foam height of example surfactants
in coating formulation A, B and C

| | Foam height - | Foam height - | Foam height - |
|---|---|---|---|
| | Formulation A | Formulation B | Formulation C |
| Example No. | (mm) | (mm) | (mm) |
| 1 | 51 | 70 | 51 |
| 2 | 5 | 16 | 5 |
| 3 | 32 | 38 | 32 |
| 4 | 30 | 29 | 30 |
| 5 | 28 | 32 | 28 |
| 6 | 31 | 33 | 31 |
| 7 | 42 | 70 | 42 |
| 8 | 28 | 43 | 71 |
| 9 | 27 | 43 | 52 |
| Control C1- | 47 | 48 | 71 |
| Lutensol ® XP-80 | | | |
| Control C2- | 40 | 45 | 71 |
| Novel ® 8-7 | | | |

Lutensol ® XP 80 is a surfactant supplied by BASF corporation and Novel ® 8-7 Ethoxylate is a surfactant supplied by Sasol Inc.

TABLE 6
Application performance of example surfactants
on sealed Leneta ™ Chart in
coating formulation A, B and C.

| | Visual rating- | Visual rating- | Visual rating- |
|---|---|---|---|
| Example | Formulation A | Formulation B | Formulation C |
| 1 | 5 | 3 | 2 |
| 2 | 5 | 5 | 2 |
| 3 | 5 | 4 | 3 |
| 4 | 5 | 5 | 3 |
| 5 | 5 | 5 | 5 |
| 6 | 5 | 4 | 4 |
| 7 | 4 | 5 | 4 |
| 8 | 4 | 4 | 3 |
| 9 | 4 | 4 | 3 |
| Control C1 - | 4 | 3 | 1 |
| Lutensol ® XP-80 | | | |
| Control C2- | 3 | 3 | 1 |
| Novel ® 8-7 | | | |

What is claimed is:

1. A surfactant comprising a reaction product of:
(i) reactant A: an aliphatic polyether polyol having a weight average molecular weight of about 100 to about 4000; and
(ii) reactant B: an epoxy compound having at least one epoxy group per molecule;
wherein the ratio of molar equivalents of “reactant A” to molar equivalents of “reactant B” is from about 1:0.5 to about 1:4.

2. The surfactant according to claim 1, wherein the surfactant further comprises a reaction product of:
(i) reactant B: an epoxy compound having at least one epoxy group per molecule; and
(ii) reactant C: an aliphatic alkoxylated alcohol having a weight average molecular weight of about 100 to about 4000.

3. The surfactant according to claim 1 or 2, wherein the aliphatic polyether polyol is a polyalkylene glycol.

4. The surfactant according to claim 1 or 2, wherein the aliphatic polyether polyol is a polyethylene glycol (PEG).

5. The surfactant according to claim 4, wherein the polyethylene glycol is selected from the group consisting of PEG 100, PEG 200, PEG 300, PEG 400, PEG 500, PEG 600, PEG 700, PEG 800, PEG 900, PEG 1000, PEG 1100, PEG 1200, PEG 1300, PEG 1400, PEG 1500, PEG 1600, PEG 1700, PEG 1800, PEG 1900, PEG 2000, PEG 2100, PEG 2200, PEG 2300, PEG 2400, PEG 2500, PEG 2600, PEG 2700, PEG 2800, PEG 2900, PEG 3000, PEG 3100, PEG 3200, PEG 3300, PEG 3400, PEG 3500, PEG 3600, PEG 3700, PEG 3800, PEG 3900, and PEG 4000.

6. The surfactant according to claim 1, wherein the epoxy compound is an alkyl glycidyl ether or allyl glycidyl ether.

7. The surfactant according to claim 6, wherein the alkyl glycidyl ether is selected from the group consisting of 2-ethylhexyl glycidyl ether (EHGE), n-butyl glycidyl ether, octyl glycidyl ether, 2-hexyldecyl glycidyl ether, 2-octyldodecyl glycidyl ether, 2-heptylundecyl glycidyl ether, 2-(1,3,3-trimethylbutyl) octyl glycidyl ether, 2-decyltetradecyl glycidyl ether, 2-dodecylhexadecyl glycidyl ether and 2-tetradecyloctadecyl glycidyl ether.

8. The surfactant according to claim 6, wherein the alkyl glycidyl ether is 2-ethylhexyl glycidyl ether (EHGE).

9. The surfactant according to claim 1, wherein the reaction product of reactant A and reactant B comprises a mixture of mono-functionalized polyol and at least one multi-functionalized polyol.

10. The surfactant according to claim 9, wherein the reactant B is an alkyl glycidyl ether and the reaction product of reactant A and reactant B comprises polyol mono-functionalized by alkyl glycidyl ether and polyol multi-functionalized by alkyl glycidyl ether.

11. The surfactant according to claim 10, wherein the reaction product of reactant A and reactant B comprises:
(i) from about 0.05% to about 40.0% of polyol mono-functionalized by alkyl glycidyl ether; and
(ii) from about 60.0% to about 99.95% of polyol multi-functionalized by alkyl glycidyl ether.

12. The surfactant according to claim 1 or 2, wherein the aliphatic polyether polyol is polyethylene glycol, and the epoxy compound is 2-ethylhexyl glycidyl ether.

13. The surfactant according to claim 12, wherein the ratio of molar equivalents of polyethylene glycol to molar equivalents of 2-ethylhexyl glycidyl ether is about 1:2.

14. A process for preparing the surfactant of claim 1 comprising:
reacting (i) about 1 molar equivalent of an aliphatic polyether polyol and (ii) about 2 molar equivalents of an epoxy compound in the presence of about 0.05 molar equivalent of a base to form a mixture of polyol mono-functionalized by the epoxy compound and at least one polyol multi-functionalized by the epoxy compound.

15. The process according to claim 14, wherein the epoxy compound is provided with at least one epoxy group per molecule.

16. The process according to claim 14, wherein the epoxy compound is an alkyl glycidyl ether or allyl glycidyl ether.

17. The process according to claim 14, wherein the reaction is conducted at a temperature of from about 80° C. to about 120° C.

18. The process according to claim 14, wherein the base is selected from the group consisting of:
(i) amines selected from the group of triethylamine, 4-(dimethylamino)pyridine, and 1,1,3,3-tetramethylguanidine, and
(ii) oxides, hydroxides, carbonates and bicarbonates of sodium, potassium, and calcium, and combinations thereof.

19. The process according to claim 14, wherein the base is sodium hydroxide or potassium hydroxide.

20. A surfactant comprising a reaction product of:
(i) polyethylene glycol (PEG) having a weight average molecular weight of about 100 to about 4000; and
(ii) 2-ethylhexyl glycidyl ether (EHGE);
wherein 1 molar equivalent of PEG reacts with 2 molar equivalents of EHGE to form a mixture of PEG mono-functionalized by EHGE, PEG di-functionalized by EHGE, PEG tri-functionalized by EHGE, PEG tetra-functionalized by EHGE, and PEG penta-functionalized by EHGE and having a generic structure of: 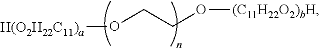
wherein each C₁₁H₂₂O₂ unit is independently 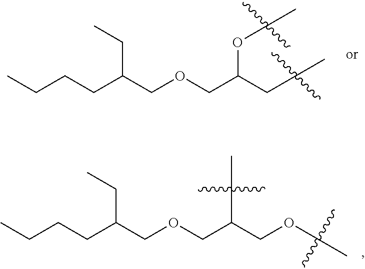 [SMILES: *CC(COCC(CC)CCCC)O* ; *OCC(*)COCC(CC)CCCC]
wherein each C₁₁H₂₂O₂ unit is attached to the polyethylene glycol core or another C₁₁H₂₂O₂ unit by a carbon-oxygen single bond; and
wherein n=2 to 90 and a+b=1 to 5, comprising
PEG mono-functionalized by EHGE, having a+b=1;
PEG di-functionalized by EHGE, having a+b=2;
PEG tri-functionalized by EHGE, having a+b=3;
PEG tetra-functionalized by EHGE, having a+b=4; and
PEG penta-functionalized by EHGE, having a+b=5.

21. The surfactant according to claim 2, wherein the aliphatic alkoxylated alcohol has a structure of: 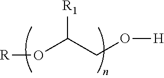
wherein R is a linear or branched alkyl group having 1 to 20 carbons; R₁=H and/or CH₃ and n=1-25.

22. The surfactant according to claim 21, wherein the aliphatic alkoxylated alcohol is selected from the group consisting of C₆-20 alcohol ethoxylates having 3 to 23 ethoxylate units.

23. A composition comprising:
(i) about 5.0 wt. % to about 99.5 wt. % of surfactant of claim 1 or 2; and
(ii) about 0.5 wt. % to about 95.0 wt. % of at least one additive.

24. The composition according to claim 23, wherein the at least one additive is selected from the group consisting of coalescent agents, film-forming agents, emulsifiers, stabilizers, rheology modifiers, cosolvents, dispersing agents, defoamers, wet-edge additives, wetting agents, humectants, wax, colorants, thickeners, anticaking agents; antifoaming agents, UV absorbers, pigments, antifreeze agents, gel inhibitors, preservatives, hydrophobic agents, adhesion promoters, biocides, anti-oxidants and plasticizers.

25. The composition according to claim 23, wherein the composition is used in paper products, metal coatings, architectural coatings, graphic arts, fibrous materials, films, sheets, composites, printing inks, inkjet printing, flock and other adhesives, hair care products, skin care products, nail care products, house-hold products, livestock/agriculture, wood coatings, textile products, nonwoven coatings, and seed applications.

26. A coating composition comprising:
(i) about 0.1 wt. % to about 5.0 wt. % of the surfactant of claim 1 or 2;
(ii) about 5.0 wt. % to about 85.0 wt. % of at least one film forming polymer; and
(iii) about 10.0 wt. % to about 94.9 wt. %, of at least one additive.

27. The coating composition of claim 26, wherein the film forming polymer is selected from the group consisting of acrylics, vinyl acrylics, styrene-acrylic copolymers, styrene-butadiene copolymers, vinyl acetate-ethylene copolymers, butadiene-acrylonitrile copolymers, polyepoxides, polyurethanes, polyamides, urethane acrylics, vinyl esters of neodecanoic acid, and polyesters.

28. The coating composition according to claim 26, wherein the at least one additive is selected from the group consisting of coalescent agents, emulsifiers, stabilizers, rheology modifiers, cosolvents, dispersing agents, defoamers, wet-edge additives, wetting agents, humectants, wax, colorants, thickeners, anticaking agents, antifoaming agents, UV absorbers, antifreeze agents, gel inhibitors, preservatives, hydrophobic agents, adhesion promoters, biocides, anti-oxidants, pigment and plasticizers.

29. The coating composition of claim 28, wherein the pigment is selected from the group consisting of phthalocyanines, iron oxides, titanium dioxides, zinc oxide, indigo, hydrated aluminum oxide, barium sulfate, calcium silicate, clay, silica, talc, calcium carbonate, and mixtures thereof.

30. The coating composition according to claim 26, wherein the composition is used for lacquer coating, primer coating, ink jet printing, top coating, varnish coating, architectural coating, wood coating, printing inks or metallic or non-metallic coating.

31. The coating composition according to claim 26, wherein the composition is coated on a substrate selected from the group consisting of porous and non-porous substrates, papers, non-woven materials, textiles, leather, wood, concrete, masonry, metals, non-metals, house wrap, building materials, fiberglass, polymeric articles, face masks, medical drapes and gowns, carpets, upholstery, tents, awnings, air bags, fabrics, ceramics, yarns, and blends, woven, knitted, natural, synthetic, and regenerated substrates.
